(19) United States
(12) Patent Application Publication
(10) Pub. No.: US 2013/0048592 A1
(43) Pub. Date: Feb. 28, 2013

(54) Bottle With Integrated Cap Remover

(71) Applicant: Steven M. CARLEY, Crescent City, IL (US)

(72) Inventor: Steven M. CARLEY, Crescent City, IL (US)

(21) Appl. No.: 13/482,346

(22) Filed: May 29, 2012

Related U.S. Application Data
(60) Provisional application No. 61/525,908, filed on Aug. 22, 2011.

(51) Int. Cl. B67B 7/18; B65D 8/04; B65D 41/04

(52) U.S. Cl. 215/302; 215/378; 53/492

(57) ABSTRACT

A bottle with an integrated cap remover allows a user to remove a twist-off bottle cap without the need for a separate bottle opener. The bottle includes a bottle cap, a bottle opening, a neck, a side wall, and a bottom surface. The bottom surface includes an indent that has a plurality of indent ridges. The bottle cap has a plurality of cap ridges. The bottle cap of a second bottle can be pressed into the primary indent of a first bottle. Twisting the first bottle will cause the indent ridges of the first bottle to engage against the cap ridges of the second bottle. The bottle cap of the second bottle will then be loosened, allowing a user to easily remove the bottle cap.

The current application claims a priority to the U.S. Provisional Patent application Ser. No. 61/525,908 filed on Aug. 22, 2011.

### FIELD OF THE INVENTION

The present invention relates generally to an apparatus for beverage bottles. More specifically, the present invention is a beverage bottle with a bottle cap shaped indent on the bottom surface of the bottle, for placing on the cap of a closed bottle and twisting to open the bottle.

### BACKGROUND OF THE INVENTION

Twist-off bottle caps are widely used to cover the opening of beverage bottles. These bottle caps are pressed around screw threads at the opening of the bottle, thereby allowing users to open the bottle by twisting the cap. As these caps often have a series of teeth or ridges which can be sharp, it can be difficult for users to twist open the bottle by hand. Though opening such caps by hand is possible, it is often uncomfortable and sometimes the ridges may cut into a user's palm. A common solution for this problem is wrapping the hem of one's garment around the teeth/ridges. However, this method often results in holes and other damages to the garment. It is therefore an object of the present invention to provide a beverage bottle with an integrated cap remover, which eliminates the possibility of hurting one's hand or damaging one's garment while trying to open a twist-off bottle cap.

### BRIEF DESCRIPTION OF THE DRAWINGS

FIG. 1 is a bottom perspective view of a bottle of the present invention.

FIG. 2 is a alternate perspective view thereof.

FIG. 3 is a slightly angled perspective view thereof.

FIG. 4 is a bottom plan view thereof.

FIG. 5 is a front elevational view thereof showing the plane upon which a sectional view is taken and shown in FIG. 6.

FIG. 6 is a right-side cross-sectional view thereof.

FIG. 7 is a bottom perspective view of a bottle and bottle cap of the present invention.

FIG. 8 is a top perspective view thereof.

FIG. 9 is a bottom perspective exploded view thereof.

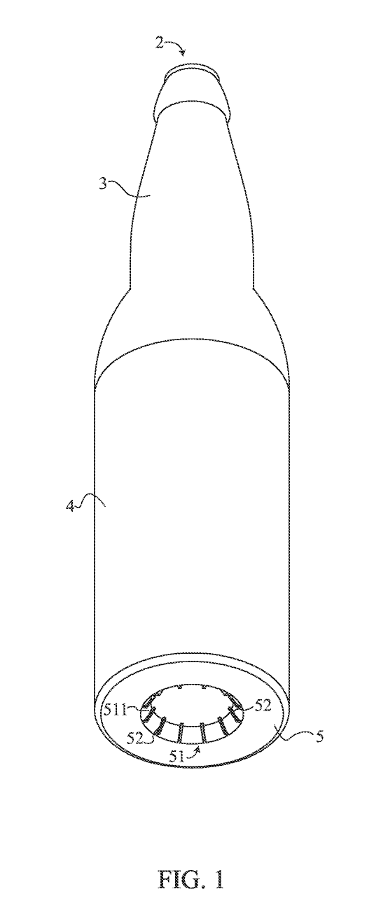

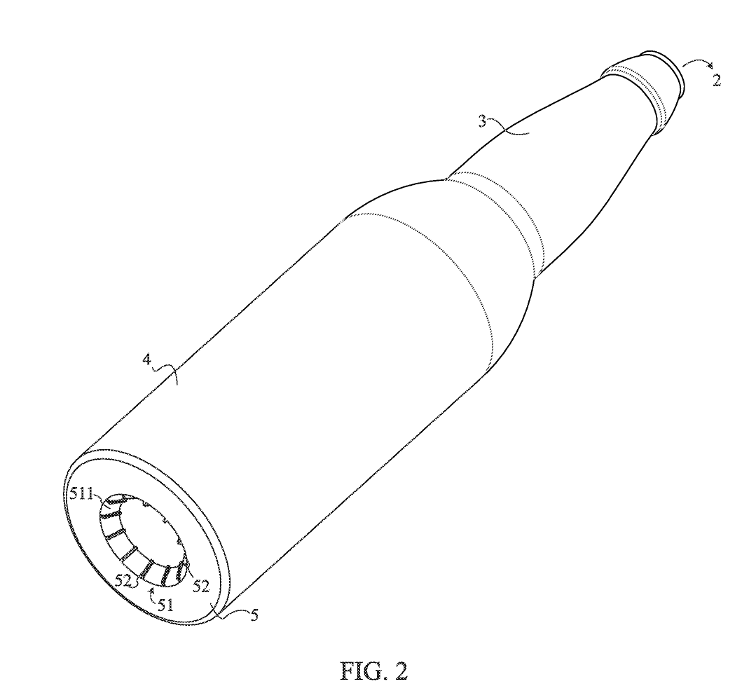

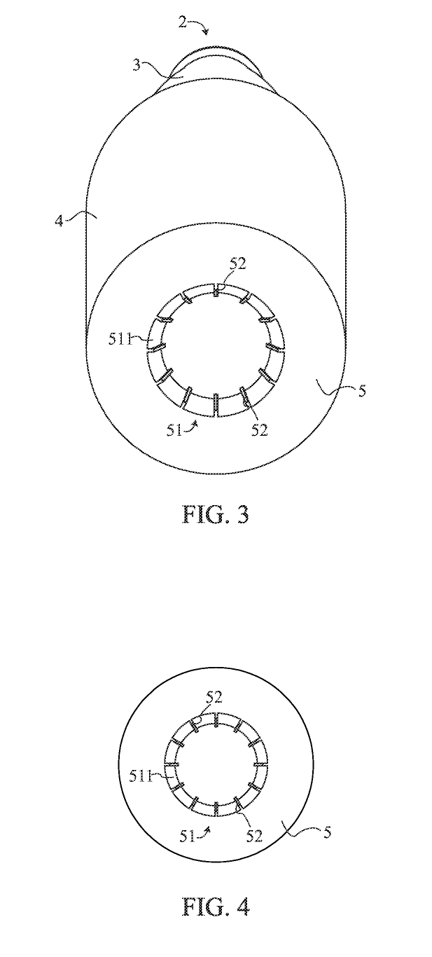

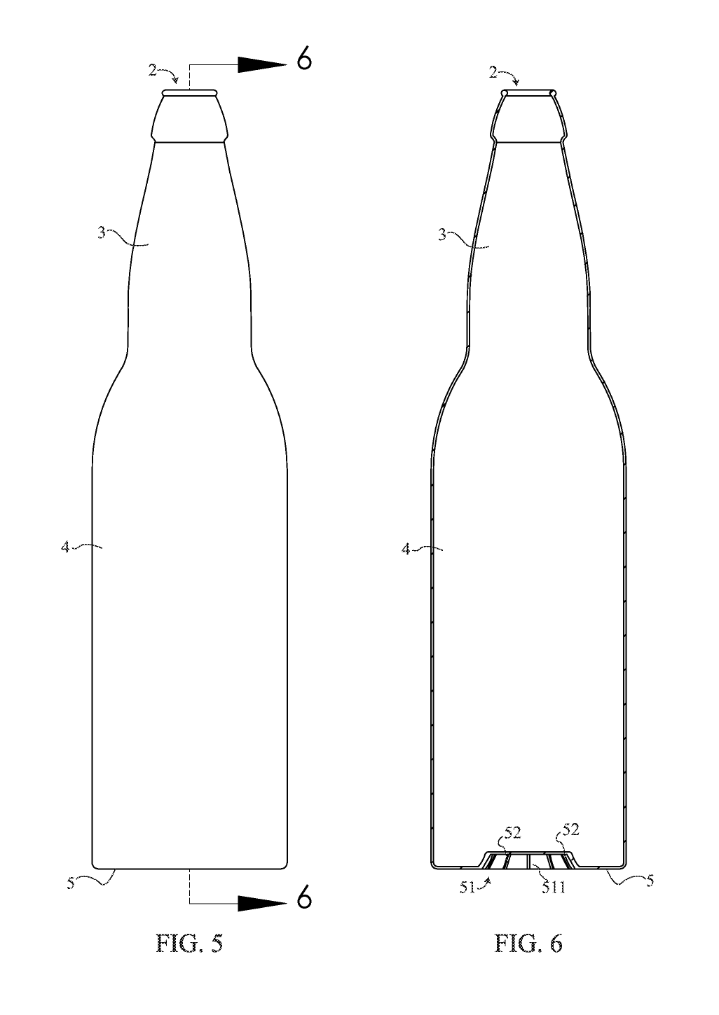

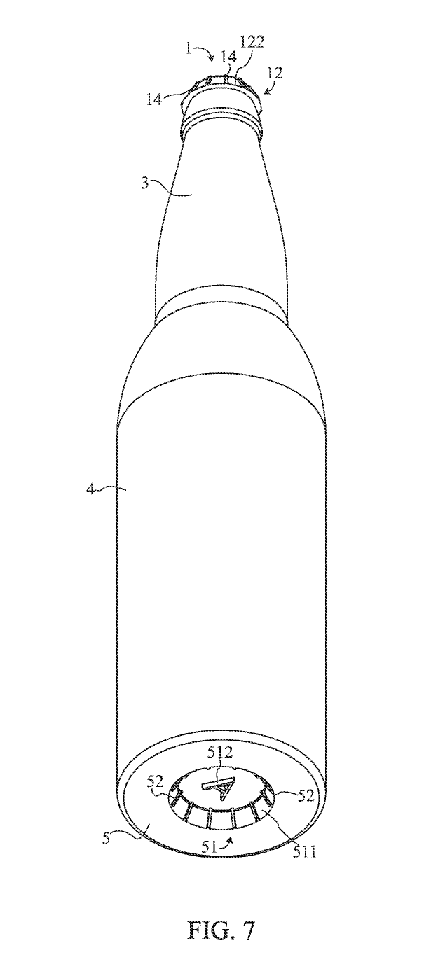

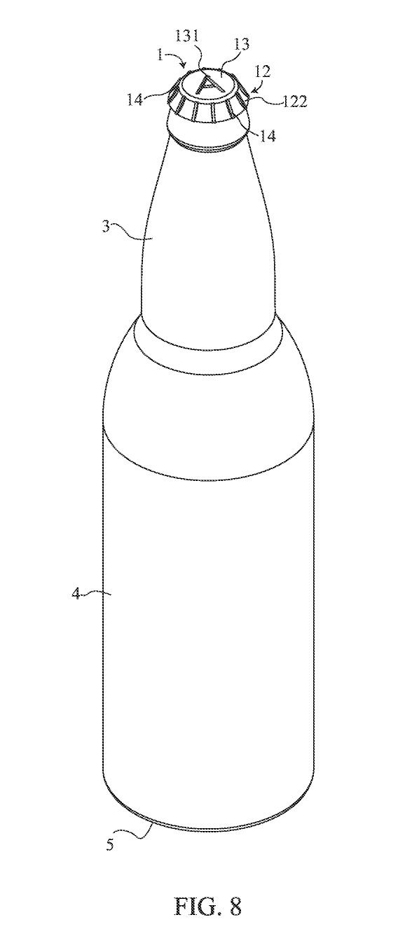

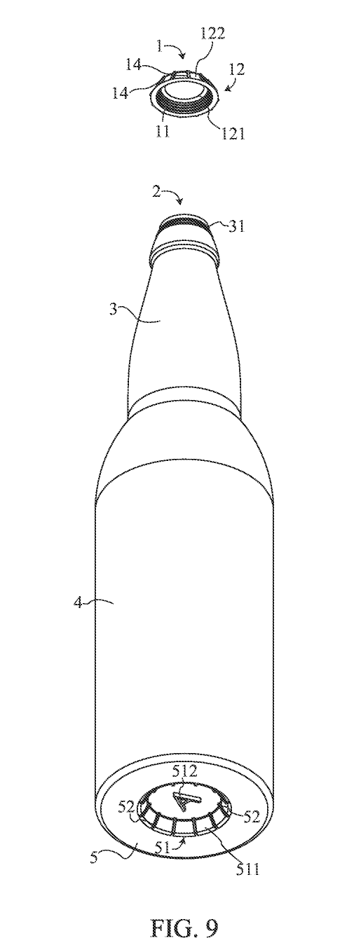

### DETAIL DESCRIPTIONS OF THE INVENTION

All illustrations of the drawings are for the purpose of describing selected versions of the present invention and are not intended to limit the scope of the present invention.

The present invention is a bottle which allows a user to easily remove the cap from another bottle. The bottle with an integrated cap remover comprises a bottle cap 1, a bottle opening 2, a neck 3, a side wall 4, and a bottom surface 5. The side wall 4 extends from the edge of the bottom surface 5 to the neck 3. The neck 3 then tapers to a bottle opening 2. The bottom surface 5, side wall 4, neck 3, and bottle opening 2 are connected such that the bottle has a generally round shape that is wider at the bottom surface 5 and smaller at the bottle opening 2. The bottle cap 1 is attached at the bottle opening 2. There is a indent 51 on the bottom surface 5 which is in the form of a bottle cap 1, allowing a bottle cap 1 of one bottle to fit securely inside the indent 51 of another bottle. The side wall 4 serves as a wider housing for beverages stored in the bottle, while the neck 3 tapers to the bottle opening 2 to facilitate drinking from the bottle.

The bottle cap 1 further comprises a lateral wall 12, a top surface 13, and a plurality of cap ridges 14. The lateral wall 12 itself comprises an interior side 121 and an exterior side 122. while the top surface 13 comprises a stylized indent 131. The lateral wall 12 is circular, with the top surface 13 connected to and covering the lateral wall 12. The lateral wall 12 is left open on the side opposite the top surface 13. The top surface 13 may be flat or rounded. The stylized indent 131 cuts into the bottle cap 1. The interior side 121 of the lateral wall 12 contains the cap threading 11, which twists around the interior side 121 of the lateral wall 12. Located on the exterior side 122 of the lateral wall 12 is the plurality of cap ridges 14. The cap ridges 14 are a set of individual ridges that form a circle around the exterior side 122 of the lateral wall 12, with each ridge protruding from the exterior side 122. The cap ridges 14 are perpendicular to the exterior side 122.

In the preferred embodiment the lateral wall 12 is circular in shape, forming a band. In other embodiments the exterior side 122 could be given a different shape; instead of being circular the exterior side 122 could be rectangular or even a prism.

Various other shapes could be used as well. However, unlike the exterior wall, the interior wall must remain circular in shape; if the interior wall is not circular in shape then the bottle cap 1 would be unable to secure to the neck threading 31 on to the neck 3 of the bottle.

The neck 3 further comprises neck threading 31. The neck threading 31 twists around the outside of the neck 3 and is located next to the bottle opening 2. The neck threading 31 matches up with the cap threading 11 on the bottle cap 1, allowing the bottle cap 1 to be attached to the bottle by screwing the bottle cap 1 onto the neck 3.

The bottom surface 5 further comprises a indent 51 and a plurality of indent ridges 52. The indent 51 itself comprises an external wall 511 and a stylized extrusion 512. The indent 51 cuts into the bottom surface 5, being formed by an external wall 511 In another embodiment, the external wall 511 could be slanted, such that the indent 51 slightly tapers as it cuts into the bottom surface 5. A slanted external wall 511 could prove more advantageous than a perpendicular external wall 511. In the preferred embodiment the indent 51 is rounded and circular in shape. The indent ridges 52, like the cap ridges 14, are a set of individual ridges that form a circle which is concentric with the external wall 511. The indent ridges 52 protrude from the external wall 511 of the indent 51. The stylized extrusion 512 extends from the indent 51 on the bottom surface 5, in a direction opposite the bottom surface 5. Generally, the stylized extrusion 512 will be shaped to match the stylized indent 131 of the top surface 13 of the bottle cap 1. For example, if the stylized indent 131 of the bottle cap 1 is a character, the stylized extrusion 512 will also be a character.

In other embodiments, the indent 51 may take different shapes, rather than being circular. However, the shape given to the indent 51 must match the shape of the exterior side 122 of the lateral wall 12 and the top surface 13 of the bottle cap 1. For example, in the preferred embodiment the circular exterior side 122 fits into the circular indent 51. In another embodiment where the external side is shaped like a square and the top surface 13 is shaped like a pyramid, the indent 51 would have to be designed with a square base and pyramid-like top. As long as the shape of the exterior side 122 matches the shape of the indent 51 and the shape of the top surface 13 matches the shape of the indent 51, various other embodiments can be made from the present invention. If the shapes are matched, then the bottle cap 1 will still be able to fit into the indent 51, retaining the function of the preferred embodiment of the present invention.

In the preferred embodiment the stylized extrusion 512 and the stylized indent 131 take the form of a logo, mark, or symbol (such as that of a company), helping to distinguish the bottle from other brands. The stylized extrusion 512 is thus capable of being inserted into the stylized indent 131 of the top surface 13 of the bottle cap 1. The stylized indent 131 would take the form of a matching logo, mark, or symbol, being shaped to received the stylized extrusion 512. The matching stylized indent 131 and stylized extrusion 512 would allow the stylized extrusion 512 to be inserted into the stylized indent 131. The stylized indent 131 and stylized extrusion 512 allow a company to brand the present invention without sacrificing functionality.

In other embodiments, the location of the stylized indent 131 and the stylized extrusion 512 could be swapped. In these other embodiments the stylized indent would be positioned on the indent 51, further cutting into the bottom surface 5. Meanwhile, the stylized extrusion 512 would be positioned on the top surface 13 of the bottle cap 1. In these other embodiments the stylized indent 131 and stylized extrusion 512 would function the same as in the preferred embodiment.

The bottle with an integrated cap remover allows a user to easily remove bottle caps 1 with cap ridges 14, such as a standard twist-off crown cap, from a bottle. This can be done using two bottles with integrated cap removers, making opening bottles a quick and easy process.

To open a bottle, a user takes a first bottle and a second bottle. After grasping each bottle, the bottle cap 1 of the second bottle is pressed into the indent 51 of the first bottle, with the stylized indent 131 of the second bottle receiving the stylized extrusion 512 of the first bottle. Force is applied in the direction of the bottom surface 5 of the first bottle. The stylized extrusion 512 and stylized indent 131 help to increase the surface area upon which force may be applied.

While pressing the bottle cap 1 and stylized indent 131 of the second bottle into the indent 51 and stylized extrusion 512 of the first bottle, a user then twists the first bottle while holding the second bottle, preventing the second bottle from rotating. This will cause the indent ridges 52 of the first bottle to lock against and engage with the cap ridges 14 of the second bottle. As the user twists the first bottle, the indent ridges 52 of the first bottle will press against the cap ridges 14 of the second bottle, causing the bottle cap 1 of the second bottle to rotate with the first bottle and become loosened.

After the bottle cap 1 of the second bottle has been loosened a user can then put the first bottle away, such as in a fridge or on a counter. The user can then take their free hand to finish unscrewing the bottle cap 1 (if necessary) and easily remove the loosened bottle cap 1 off of the second bottle.

Though the method above discusses twisting the first bottle while holding the second bottle steady, a user could instead twist the second bottle while holding the first bottle steady. A user could also twist the first bottle and second bottle in opposite directions. In each instance, the cap ridges 14 of the second bottle still engage against the indent ridges 52 of the first bottle. As a result, the bottle cap 1 of the second bottle is still twisted and loosened, achieving the same end result.

The present invention can be applied to any bottle that uses a ridged twist-off cap. Examples include soda bottles, beer bottles, water bottles, and other bottles. The bottles utilizing the present invention do not necessarily have to contain liquid; the present invention could be applied to pharmaceutical (e.g. aspirin) bottles, for example. The bottles can be made of a variety of materials, such as glasses and plastics, without hampering the function of the present invention.

Although the invention has been explained in relation to its preferred embodiment, it is to be understood that many other possible modifications and variations can be made without departing from the spirit and scope of the invention as hereinafter claimed.

What is claimed is:

1. A bottle with an integrated cap remover comprises,
a bottle cap;
a bottle opening;
a neck;
a side wall;
a bottom surface;
the bottle cap comprises a cap threading, a lateral wall, a top surface, and a plurality of cap ridges;
the top surface further comprises a stylized indent;
the neck comprises a neck threading;
the bottom surface comprises an indent and a plurality of indent ridges;
the indent further comprises an external wall and a stylized extrusion;
the neck being parametrically connected to the side wall;
the bottom surface being parametrically connected to the side wall opposite the neck;
the top surface of the bottle cap being parametrically connected to the lateral wall;
the bottle opening being located on the neck; and
the bottle cap being attached to the neck.

2. The bottle with an integrated cap remover as claimed in claim 1 comprises, the stylized indent being positioned on the top surface;
the stylized indent traversing into the bottle cap;
the lateral wall further comprises an interior side and an exterior side;
the cap threading being positioned on the interior side of the bottle cap;
the plurality of cap ridges being positioned radially around the exterior side of the bottle cap; and
the plurality of cap ridges being perpendicular to the exterior side of the bottle cap.

3. The bottle with an integrated cap remover as claimed in claim 1 comprises,
the neck being tapered towards the bottle opening.

4. The bottle with an integrated cap remover as claimed in claim 1 comprises,
the neck threading being positioned on the neck adjacent to the bottle opening.

5. The bottle with an integrated cap remover as claimed in claim 1 comprises,
the indent being concave;
the indent traversing into the bottom surface;
the stylized extrusion being positioned on the indent;
the stylized extrusion being oriented opposite of the indent;
the plurality of indent ridges being positioned radially around the external wall of the indent; and
the plurality of indent ridges being perpendicular to the external wall.

6. The bottle with an integrated cap remover as claimed in claim 5 comprises,
the stylized extrusion engaging with the stylized indent; and
wherein the stylized extrusion forms a logo, a mark, or a symbol and the stylized indent is shaped to delineate the logo, the mark, or the symbol.

7. A method for removing a bottle cap using a bottle with an integrated cap remover comprises the steps of:
providing a first bottle and second bottle, wherein both the first bottle and the second bottle each comprise a bottle cap, an indent, a stylized extrusion, a stylized indent, a plurality of cap ridges, and a plurality of indent ridges;
grasping the first bottle with a first hand;
grasping the second bottle with a second hand;
moving the second bottle to secure the bottle cap of the second bottle in the indent of the first bottle;
twisting the first bottle to twist and unlock the bottle cap of the second bottle;
preventing the second bottle from twisting by holding the second bottle tightly;
removing the first hand from the first bottle;
grasping the bottle cap of the second bottle with the first hand; and
removing the bottle cap of the second bottle with the first hand.

8. The method for removing a bottle cap using a bottle with an integrated cap remover as claimed in claim 7 further comprises the steps of:
pressing the bottle cap of the second bottle against the stylized extrusion of the first bottle to secure the bottle cap of the second bottle in the indent of the first bottle; and
inserting the stylized extrusion of the first bottle into the stylized indent of the second bottle to further secure the bottle cap of the second bottle in the indent of the first bottle.

9. The method for removing a bottle cap using a bottle with an integrated cap remover as claimed in claim 8, wherein the stylized extrusion of the first bottle is flush against the stylized indent of the second bottle.

10. The method for removing a bottle cap using a bottle with an integrated cap remover as claimed in claim 7 further comprises the step of:
engaging the plurality of cap ridges of the second bottle against the plurality of indent ridges of the first bottle when twisting the second bottle.

11. The method for removing a bottle cap using a bottle with an integrated cap remover as claimed in claim 7 further comprises the step of:
placing the first bottle on a secure surface prior to removing the first hand from the first bottle.

12. The method for removing a bottle cap using a bottle with an integrated cap remover as claimed in claim 7, wherein the bottle cap of the second bottle has been loosened by twisting the first bottle, allowing the first hand to easily remove the bottle cap of the second bottle.

13. A bottle with an integrated cap remover comprises,
a bottle cap;
a bottle opening;
a neck;
a side wall;
a bottom surface;
the bottle cap comprises a cap threading, a lateral wall, a top surface, and a plurality of cap ridges;
the lateral wall further comprises an interior side and an exterior side;
the top surface further comprises a stylized indent;
the neck comprises a neck threading;
the bottom surface comprises an indent and a plurality of indent ridges;
the indent further comprises an external wall and a stylized extrusion;
the neck being parametrically connected to the side wall;
the bottom surface being parametrically connected to the side wall opposite the neck;
the top surface of the bottle cap being parametrically connected to the lateral wall;
the plurality of cap ridges being positioned radially around the exterior side of the bottle cap;
the stylized indent being positioned on the top surface;
the stylized indent traversing into the bottle cap;
the bottle opening being located on the neck;
the bottle cap being attached to the neck;
the indent being concave;
the indent traversing into the bottom surface;
the stylized extrusion being positioned on the indent;
the stylized extrusion being oriented opposite of the indent;
wherein the stylized extrusion forms a logo, a mark, or a symbol and the stylized indent is shaped to delineate the logo, the mark, or the symbol; and
the plurality of indent ridges being positioned radially around the external wall of the indent.

14. The bottle with an integrated cap remover as claimed in claim 13 comprises, the cap threading being positioned on the interior side of the bottle cap; and
the plurality of cap ridges being perpendicular to the exterior side of the bottle cap.

15. The bottle with an integrated cap remover as claimed in claim 13 comprises,
the neck being tapered towards the bottle opening; and
the neck threading being positioned on the neck adjacent to the bottle opening.

16. The bottle with an integrated cap remover as claimed in claim 13 comprises,
the stylized extrusion being positioned adjacent to the external wall;
the plurality of indent ridges being perpendicular to the external wall; and
the stylized extrusion engaging with the stylized indent.
